(19) United States
(12) Patent Application Publication
(10) Pub. No.: US 2025/0202004 A1
(43) Pub. Date: Jun. 19, 2025

(54) MULTILAYER BATTERY PACK INSULATOR AND METHOD OF CONSTRUCTION THEREOF

(71) Applicant: FEDERAL-MOGUL POWERTRAIN LLC, Northville, MI (US)

(72) Inventors: Ritesh Mehbubani, Royersford, PA (US); Junhan Tao, Chester Springs, PA (US); Zobar Hassan, Elmont, NY (US); Daniel Rowcotsky, Dresher, PA (US)

(21) Appl. No.: 18/964,421

(22) Filed: Nov. 30, 2024

Related U.S. Application Data
(60) Provisional application No. 63/610,022, filed on Dec. 14, 2023.

(51) Int. Cl. H01M 50/24; B32B 5/02; B32B 7/05; B32B 7/12; B32B 27/12; H01M 50/222; H01M 50/227; H01M 50/231

(52) U.S. Cl. CPC H01M 50/24; B32B 5/022; B32B 7/05; B32B 7/12; B32B 27/12; H01M 50/222; H01M 50/227; H01M 50/231; B32B 2250/03; B32B 2250/40; B32B 2262/10; B32B 2307/3065; B32B 2307/546; B32B 2307/7376; B32B 2457/10; B32B 2605/08; H01M 2220/20

(57) ABSTRACT

A flexible multilayer battery pack insulator for an electric vehicle includes a first outer film layer having opposite outer and inner first outer film layer sides, a second outer film layer having opposite outer and inner second outer film layer sides, and an intermediate fabric layer sandwiched between the inner side of the first outer film layer and the inner side of the second outer film layer and in contact with the inner side of the first outer film layer and in contact with the inner side of the second outer film layer.

### CROSS-REFERENCE TO RELATED APPLICATION

This application claims the benefit of U.S. Provisional Application Ser. No. 63/610,022, filed Dec. 14, 2023, which is incorporated herein by reference in its entirety.

### BACKGROUND OF THE INVENTION

### 1. Technical Field

This invention relates generally to thermal insulators, and more particularly to multilayer thermal insulators for inhibiting flame propagation within and from a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation, such as may be experienced in a thermal runaway condition of one or more cells of the electric vehicle battery pack. As shown in FIGS. 2A-2C, a battery pack 12 and housing 14, also referred to as casing, thereof are shown having a fiberglass insulator between and about cells 16 of the battery pack 12. The fiberglass insulator can result in a thermal runaway condition originating in any one of the cells 16 of the battery pack 12, such that flame propagates from a single cell 16 (FIG. 2A) to multiple cells (FIG. 2C), in less than 10 minutes at a temperature of 1000° C.

It is desired to provide a thermal insulation that inhibits the propagation of flame between cells of a battery pack when exposed to a flame at a distance of about 25 mm for 10 minutes or more at a temperature of 1200° C.-1400° C.

### SUMMARY OF THE INVENTION

It is an object of the present disclosure to provide a flexible multilayer material for use with an electric vehicle battery pack that addresses at least the desire to inhibit the propagation of flame within and from the battery pack for 10 minutes or more at a temperature of 1000-1200° C.

It is a further object of the present disclosure to provide a flexible multilayer material for use with an electric vehicle battery pack that is flexible, lightweight, has a thin, low profile to minimize the amount of space occupied by the thermal insulator, and is economical in manufacture and in use.

One aspect of the invention provides a flexible multilayer battery pack insulator for an electric vehicle. The flexible multilayer battery pack insulator includes a first outer film layer having opposite outer and inner sides, a second outer film layer having opposite outer and inner sides, and an intermediate fabric layer sandwiched between the inner side of the first outer film layer and the inner side of the second outer film layer and in contact with the inner side of the first outer film layer and in contact with the inner side of the second outer film layer.

In accordance with another aspect of the invention, the flexible multilayer battery pack insulator can further include an adhesive bonded to the outer side of the first outer film layer and an adhesive bonded to the outer side of the second outer film layer.

In accordance with another aspect of the invention, the adhesive is a pressure-sensitive adhesive.

In accordance with another aspect of the invention, the first outer film layer is an impervious polymeric film.

In accordance with another aspect of the invention, the second outer film layer is an impervious polymeric film.

In accordance with another aspect of the invention, the impervious polymeric film is one of polyester, nylon, polyimide, and PTFE.

In accordance with another aspect of the invention, the impervious polymeric film has a thickness between about 0.1 to 5 mm.

In accordance with another aspect of the invention, the intermediate fabric layer is one or more of a nonwoven material, woven material, and knitted material.

In accordance with another aspect of the invention, the intermediate fabric layer is a nonwoven material made of an inorganic material.

In accordance with another aspect of the invention, the inorganic material is one or more of ceramic material, fiberglass, silica, basalt, s-2 glass, and hr fiberglass.

In accordance with another aspect of the invention, the first outer film layer, the second outer film layer, and the intermediate fabric layer are laminated together.

In accordance with another aspect of the invention, the first outer film layer, the second outer film layer, and the intermediate fabric layer have outer peripheries and are laminated together via at least one weld seam extending adjacent the outer peripheries.

In accordance with another aspect of the invention, the at least one weld seam is an ultrasonic weld seam, and the first outer film layer, the second outer film layer, and the intermediate fabric layer are detached from one another inwardly of the at least one weld seam.

In accordance with another aspect of the invention, the at least one weld seam includes weld seams spaced in generally parallel relation from one another along opposite outer peripheries, the first outer film layer, the second outer film layer, and the intermediate fabric layer being detached from one another across the entirety of a region extending from one weld seam to the other weld seam.

In accordance with another aspect of the invention, the at least one weld seam is a continuous, annular weld seam extending about the entirety of the outer peripheries.

In accordance with another aspect of the invention, the first outer film layer, the second outer film layer, and the intermediate fabric layer have a combined maximum thickness between about 0.1 mm to 11 mm.

In accordance with another aspect of the invention, the first outer film layer and the second outer film layer can each have a thickness between about 1 nanometer to 3 mm.

In accordance with another aspect of the invention, the intermediate layer can have a thickness between about 0.1 mm to 5 mm.

In accordance with another aspect of the invention, the first outer film layer, the second outer film layer, and the intermediate fabric layer provide a combined thermal conductivity less than 0.07 watts/meter-Kelvin (w/wK).

In accordance with another aspect of the invention, a method of constructing a flexible multilayer battery pack insulator is provided. The method includes providing a first outer film layer having opposite outer and inner sides; providing a second outer film layer having opposite outer and inner sides; sandwiching an intermediate fabric layer between the inner side of the first outer film layer and the inner side of the second outer film layer; and fixing the first outer film layer, the second outer film layer, and the intermediate fabric layer together via at least one weld seam.

In accordance with another aspect of the invention, the method can further include leaving the first outer film layer, the second outer film layer, and the intermediate fabric layer in detached relation from one another other than where fixed together via the at least one weld seam.

In accordance with another aspect of the invention, the method can further include forming the at least one weld seam along opposite outer peripheries of the first outer film layer, the second outer film layer, and the intermediate fabric layer.

In accordance with another aspect of the invention, the method can further include forming the at least one weld seam as a continuous, annular weld seam.

In accordance with another aspect of the invention, the method can further include providing the first outer film layer and the second outer film layer as an impervious polymeric film.

In accordance with another aspect of the invention, the method can further include providing the intermediate layer as a nonwoven material.

In accordance with another aspect of the invention, the method can further include providing the nonwoven material as an inorganic material from one or more of ceramic material, fiberglass, silica, basalt, s-2 glass, and hr fiberglass.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a multilayer thermal insulator constructed in accordance with an aspect of the invention;

FIGS. 2A-2C illustrate a schematic representation of an electric vehicle battery pack in accordance with prior art undergoing a thermal runaway condition with a flame propagating without hindrance from a location of flame initiation (FIG. 2A) throughout a plurality of cells of the battery pack (FIG. 2C);

FIGS. 3A-3C are views similar to FIGS. 2A-2C, with the electric vehicle battery pack including a plurality of flexible multilayer battery pack insulators constructed in accordance with an aspect of the disclosure, with the flexible multilayer battery pack insulators shown suppressing and inhibiting flame propagating from a location of a thermal runaway condition within a single cell (FIG. 3A) throughout the plurality of cells of the battery pack (FIG. 3C);

FIG. 4 is a schematic plan view of one of the flexible multilayer battery pack insulators; and

FIG. 4A is a cross-sectional view taken generally along the line 4A-4A of FIG. 4.

### DETAILED DESCRIPTION OF PREFERRED EMBODIMENTS

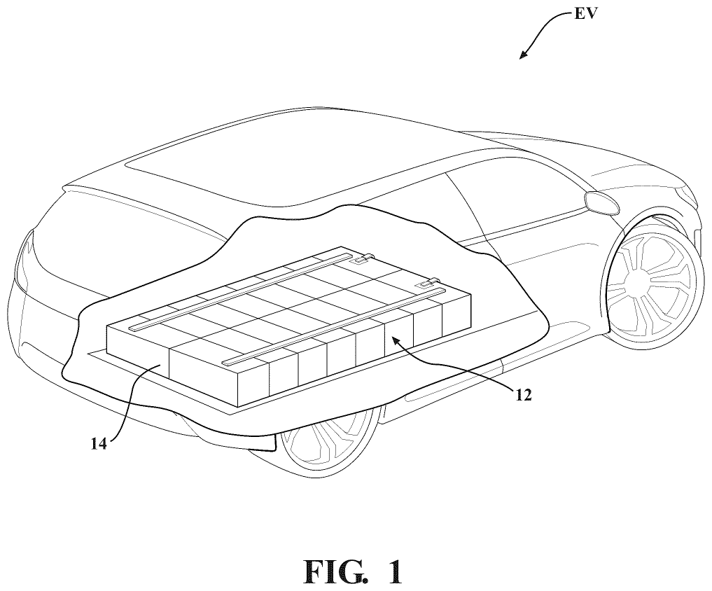

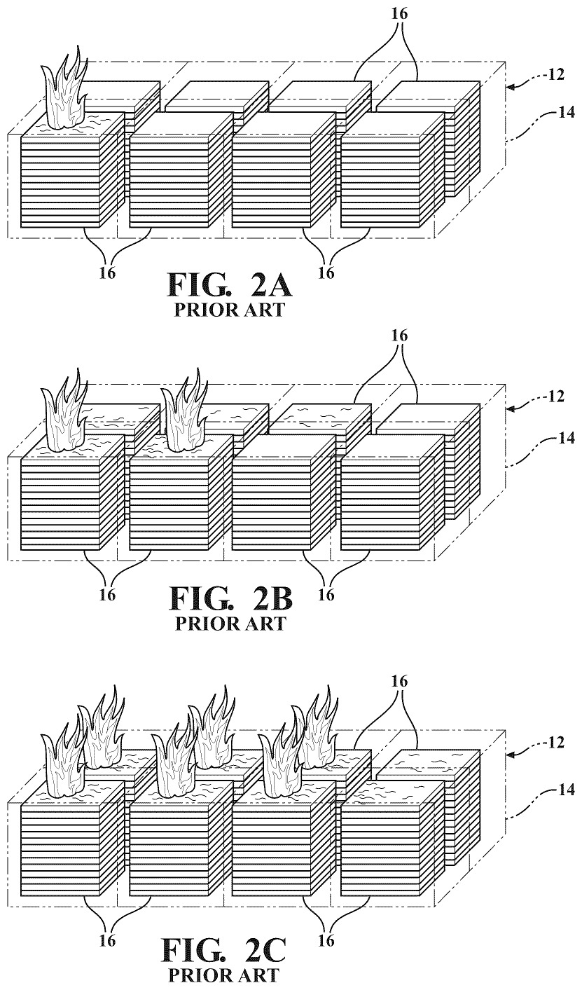

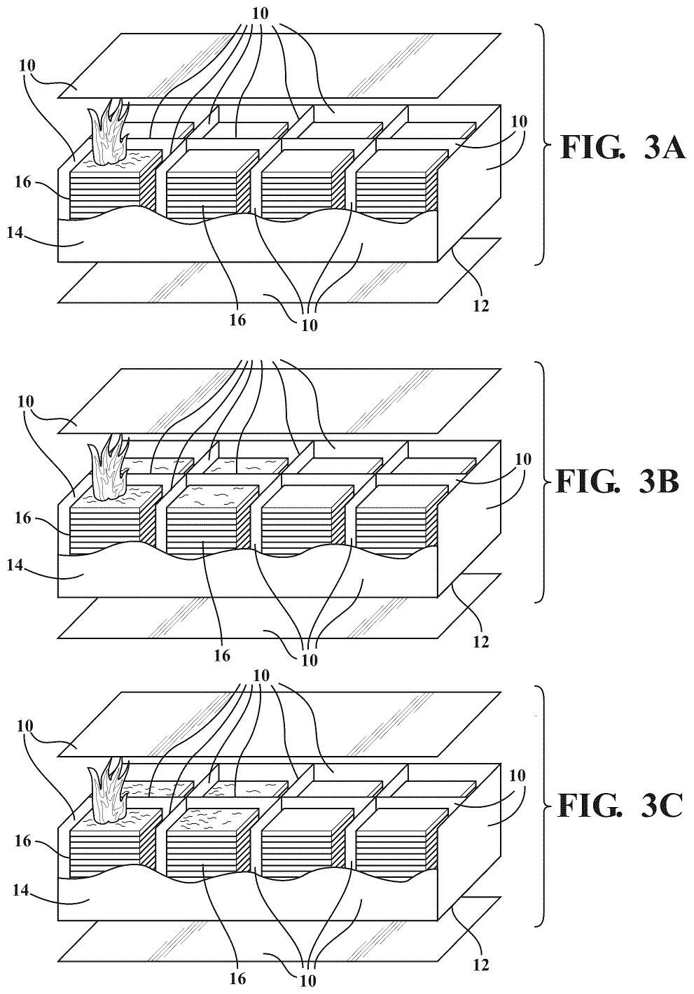

Referring in more detail to the drawings, FIG. 1 illustrates a motor vehicle, shown as an electrically powered motor vehicle, also referred to as electric vehicle EV, having a battery pack 12, such as a lithium-ion battery pack, configured with at least one insulator material, and shown as plurality of insulator materials, also referred to as flexible multilayer battery pack insulator or thermal insulator 10, in accordance with an aspect of the invention. The electric vehicle battery pack 12 includes a housing member, also referred to as housing or casing 14 bounding a plurality of cells 16, and including bus-bars interconnecting cells, high voltage electrical connectors, cell interfaces, low voltage signal wires, high voltage cables and a cooling system having cooling tubes through which coolant can flow, as is generally known in electric vehicle battery packs. During normal use, and including in non-normal situations, such as in a vehicle crash condition or some other condition causing an impact force to battery pack 12, in contrast to a battery pack 12 not having a thermal insulator 10 as disclosed herein, as shown in FIGS. 2A-2C, a thermal runaway condition originating in any one of the cells 16 of a battery pack 12, with the flexible thermal insulator 10 being disposed between and/or about the cells 16, as illustrated in FIGS. 3A-3C, is controlled and contained via the flexible thermal insulator 10, such that flame propagation is prevented for at least 10 minutes at an internal cell temperature ranging between 1200-1400° C., and an outer surface temperature of the housing 14 is maintained to be less than 400° C., and preferably 370° C., for 10 minutes. The flexible thermal insulator 10 has a thermal conductivity less than 0.07 watts/meter-Kelvin (w/wK).

As shown schematically in FIGS. 3A-3C, the thermal insulator(s) 10, which can be arranged to thermally separate and isolate the cells 16 from one another, as well as to shield and protect surfaces of the battery pack housing 14, the aforementioned bus-bars, high voltage electrical connectors, cell interfaces, low voltage signal wires, high voltage cables and any cooling tubes (not shown) against extreme temperature thermal runaway conditions and contamination, such as from fluid or debris, as well as from impact forces, such as may be experienced in a crash condition, is provided as a relatively thin, flexible multilayer wall 18, such as having a thickness as low as 0.1 mm up to about 11 mm, and preferably between about 1 mm-2 mm in thickness. The wall 18, being thin and flexible, can be configured as needed, such as by being able to be wrapped into a hollow tubular sleeve configuration about bus bars, wires, tubes, connectors and the like, and can also be used in sheet form, such as a flat planar sheet, to provide a protective outer barrier about an outer periphery of the cells 16, as well as to provide a protective barrier between adjacent cells 16 to effectively thermally isolate each cell 16 from an adjacent cell 16.

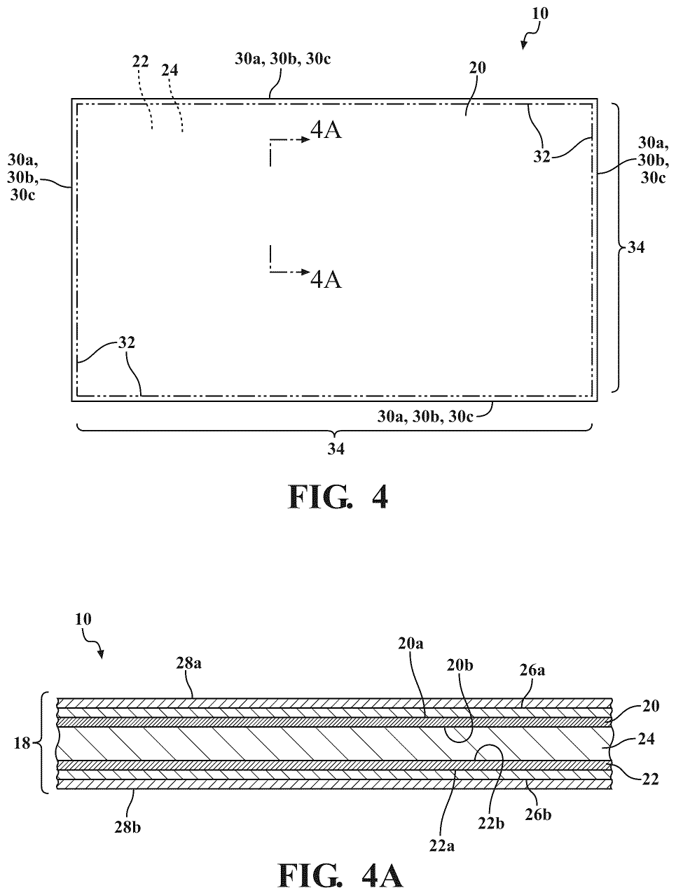

The composite wall 18, as shown schematically in FIG. 4A, includes a first outer film layer 20 having opposite outer and inner sides 20a, 20b, a second outer film layer 22 having opposite outer and inner sides 22a, 22b, and an intermediate fabric layer 24 sandwiched between the inner side 20b of the first outer film layer 20 and the inner side 22b of the second outer film layer 22.

To facilitate locating and fixing the thermal insulator 10 in place, at least one, and shown as a pair of adhesive layers 26a, 26b can be bonded to the respective outer side 20a of the first outer film layer 20 and to the outer side 22a of the second outer film layer 22. The adhesive layers 26a, 26b can be provided as pressure-sensitive adhesive layers 26a, 26b that are fire-resistant, and in one preferred embodiment, provided as an acrylic adhesive. A release layer 28a, 28b is releasably bonded to an outwardly facing side of the pressure-sensitive adhesive layer 26a, 26b facing away from the fabric layer 24 for selective removal to expose the underlying pressure-sensitive adhesive layer 26a, 26b when desired for adhesion to a desired surface of the electric vehicle battery pack 12. The pressure-sensitive adhesive layer 26a, 26b provides a minimum peal strength of 5N/25 mm under normal operating conditions.

The first outer film layer 20 and the second outer film layer 22 can be provided as impervious polymeric films. The impervious polymeric films 20, 22 can further be provided as one of polyester, nylon, polyimide, and PTFE. To enhance flexibility and reduce thickness, the impervious polymeric films each have a thickness between about 1 nanometer to 3 mm, and preferably between 1 nanometer to 0.5 mm.

The intermediate fabric layer 24 is provided as at least one or more of a nonwoven material, woven material, and knitted material. In a presently preferred embodiment, the intermediate fabric layer 24 is a nonwoven material made of an inorganic material. The inorganic material can be provided as one or more of ceramic material, fiberglass, silica, basalt, s-2 glass, and hr fiberglass. The intermediate layer 24 can have a thickness ranging between about 0.1 mm to 5 mm, and preferably between about 0.1 mm to 1 mm.

The first outer film layer 20, the second outer film layer 22, and the intermediate fabric layer 24 are laminated together. The first outer film layer 20, the second outer film layer 22, and the intermediate fabric layer 24, as shown in FIG. 4, have outer peripheries 30a, 30b, 30c, respectively, and are laminated together via at least one weld seam 32 extending adjacent the outer peripheries 30a, 30b, 30c, and shown as extending immediately along the outer peripheries 30a, 30b, 30c, thereby sealing the outer peripheries against ingress of water or debris, as well as acting to fix the layers 20, 22, 24 to one another. The weld seam 32 can be formed as an ultrasonic weld seam, with the weld seam 30 shown as extending continuously as an annular weld seam 32 about the entirety of the outer peripheries 30a, 30b, 30c. The first outer film layer 20 and the second outer film layer 22, being polymeric, facilitate formation of the ultrasonically formed weld seam 30. The first outer film layer 20, the second outer film layer 22, and the intermediate fabric layer 24 remain detached from one another inwardly of the weld seam 32, and thus, allow an air layer or gap to remain between the separate layers 20, 22, 24, thereby increasing the thermal insulation properties of the thermal insulator 10. The weld seam 32, as shown, includes weld seams 32 spaced in generally parallel relation from one another along opposite outer peripheries 30a, 30b, 30c, with the first outer film layer 20, the second outer film layer 22, and the intermediate fabric layer 24 being detached from one another across the entirety of a region 34 extending from one weld seam 32 to the opposite weld seam 32.

In accordance with another aspect of the invention, a method of constructing an insulator material 10 for use with an electric vehicle battery pack 12 is provided. The method includes providing a first outer film layer 20 having opposite outer and inner sides 20a, 20b; providing a second outer film layer 22 having opposite outer and inner sides 22a, 22b; sandwiching an intermediate fabric layer 24 between the inner side 20b of the first outer film layer 20 and the inner side 22b of the second outer film layer 22; and fixing the first outer film layer 20, the second outer film layer 22, and the intermediate fabric layer 24 together via at least one weld seam 32.

In accordance with another aspect of the disclosure, the method can further include leaving the first outer film layer 20, the second outer film layer 22, and the intermediate fabric layer 24 in detached relation from one another other than where fixed together via the at least one weld seam 32.

In accordance with another aspect of the disclosure, the method can further include forming the at least one weld seam 32 along opposite outer peripheries 30a, 30b, 30c of the first outer film layer 20, the second outer film layer 22, and the intermediate fabric layer 24.

In accordance with another aspect of the disclosure, the method can further include forming the at least one weld seam 32 as a continuous, annular weld seam.

In accordance with another aspect of the disclosure, the method can further include providing the first outer film layer 20 and the second outer film layer 22 as an impervious polymeric film.

In accordance with another aspect of the disclosure, the method can further include providing the intermediate layer 24 as a nonwoven material.

In accordance with another aspect of the disclosure, the method can further include providing the nonwoven material as an inorganic material from one or more of ceramic material, fiberglass, silica, basalt, s-2 glass, and hr fiberglass.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible multilayer battery pack insulator for an electric vehicle, comprising:
a first outer film layer having opposite outer and inner sides;
a second outer film layer having opposite outer and inner sides; and
an intermediate fabric layer sandwiched between said inner side of said first outer film layer and said inner side of said second outer film layer and in contact with the inner side of said first outer film layer and in contact with said inner side of said second outer film layer.

2. The flexible multilayer battery pack insulator of claim 1, further including an adhesive bonded to said outer side of said first outer film layer and an adhesive bonded to said outer side of said second outer film layer.

3. The flexible multilayer battery pack insulator of claim 2, wherein said adhesive is a pressure-sensitive adhesive.

4. The flexible multilayer battery pack insulator of claim 1, wherein said first outer film layer is an impervious polymeric film.

5. The flexible multilayer battery pack insulator of claim 4, wherein said second outer film layer is an impervious polymeric film.

6. The flexible multilayer battery pack insulator of claim 5, wherein said impervious polymeric film of said first outer film layer and said second outer film layer is one of polyester, nylon, polyimide, and PTFE.

7. The flexible multilayer battery pack insulator of any one of claim 6, wherein said impervious polymeric film of said first outer film layer and said second outer film layer has a thickness between about 1 nanometer to 3 mm.

8. The flexible multilayer battery pack insulator of claim 7, wherein said intermediate fabric layer includes at least one of a nonwoven material, a woven material, and a knitted material.

9. The flexible multilayer battery pack insulator of claim 8, wherein said intermediate fabric layer is a nonwoven material made of an inorganic material.

10. The flexible multilayer battery pack insulator of claim 9, wherein said inorganic material is includes at least one of a ceramic material, a fiberglass material, a silica-based material, a basalt material, a s-2 glass, and a hr fiberglass.

11. The flexible multilayer battery pack insulator of claim 1, wherein said first outer film layer, said second outer film layer, and said intermediate fabric layer are laminated together.

12. The flexible multilayer battery pack insulator of claim 11, wherein said first outer film layer, said second outer film layer, and said intermediate fabric layer have outer peripheries, each of said outer peripheries being laminated together via at least one weld seam extending adjacent said outer peripheries.

13. The flexible multilayer battery pack insulator of claim 12, wherein said at least one weld seam is an ultrasonic weld seam, and said first outer film layer, said second outer film layer, and said intermediate fabric layer are detached from one another inwardly of said at least one weld seam.

14. The flexible multilayer battery pack insulator of claim 13, wherein said at least one weld seam includes a plurality of weld seams spaced in generally parallel relation from one another along opposite outer peripheries, said first outer film layer, said second outer film layer, and said intermediate fabric layer being detached from one another across the entirety of a region extending from one weld seam to the other weld seam.

15. The flexible multilayer battery pack insulator of claim 14, wherein said at least one weld seam is a continuous, annular weld seam extending about the entirety of said outer peripheries.

16. The flexible multilayer battery pack insulator of claim 1, wherein said first outer film layer, said second outer film layer, and said intermediate fabric layer have a combined maximum thickness between about 0.1 mm to 11 mm.

17. The flexible multilayer battery pack insulator of claim 16, wherein said first outer film layer and said second outer film layer can each have a thickness between about 1 nanometer to 3 mm.

18. The flexible multilayer battery pack insulator of claim 17, wherein said intermediate layer can have a thickness between about 0.1 mm to 5 mm.

19. The flexible multilayer battery pack insulator of claim 1, wherein said first outer film layer, said second outer film layer, and said intermediate fabric layer provide a combined thermal conductivity less than 0.07 watts/meter-Kelvin (w/wK).

20. A method of constructing a flexible multilayer battery pack insulator, comprising:
providing a first outer film layer having opposite outer and inner sides;
providing a second outer film layer having opposite outer and inner sides;
sandwiching an intermediate fabric layer between the inner side of the first outer film layer and the inner side of the second outer film layer; and
fixing the first outer film layer, the second outer film layer, and the intermediate fabric layer together via at least one weld seam.
